(19) United States
(12) Patent Application Publication
(10) Pub. No.: US 2026/0205912 A1
(43) Pub. Date: Jul. 16, 2026

(54) METHOD FOR CELL RESELECTION, TERMINAL DEVICE, AND NETWORK DEVICE

(71) Applicant: SPREADTRUM COMMUNICATIONS (SHANGHAI) CO., LTD., Shanghai (CN)

(72) Inventor: Lifeng HAN, Shanghai (CN)

(21) Appl. No.: 18/868,976

(22) PCT Filed: May 26, 2023
(86) PCT No.: PCT/CN2023/096456

§ 371 Date: Nov. 25, 2024

(30) Foreign Application Priority Data
May 27, 2022 (CN) 202210590996.0

(51) Int. Cl. H04W 36/32; H04W 36/00; H04W 36/08; H04W 36/30; H04W 76/20

(52) U.S. Cl. CPC H04W 36/32; H04W 36/008355; H04W 36/08; H04W 36/30; H04W 76/20

(57) ABSTRACT

The present disclosure provides a method for cell reselection, a terminal device, and a network device. A future motion trajectory and/or a service to be initiated in the future is predicted, where the future motion trajectory is covered by at least one cell, and the service to be initiated in the future corresponds to at least one frequency. A signal quality level of the at least one cell and/or a frequency priority of the at least one frequency is adjusted. Cell reselection is performed by using the adjusted signal quality level of the at least one cell and/or the adjusted frequency priority.

### CROSS-REFERENCE TO RELATED APPLICATION(S)

This application a National Stage of International Application No. PCT/CN2023/096456, filed May 26, 2023, which claims priority to and the benefit of Chinese Patent Application No. 202210590996.0, filed May 27, 2022, the entire disclosure of both of which are hereby incorporated by reference.

### TECHNICAL FIELD

The present disclosure relates to the field of communication technology, and in particularly to a method for cell reselection, a terminal device, and a network device.

### BACKGROUND

In the related art, when a terminal device performs cell reselection, the terminal device only performs reselection according to a cell reselection parameter(s) configured by an access network device, so that personalized cell reselection of the terminal device cannot be realized, which may cause some unnecessary and unsuitable cell reselection. For example, the terminal device may camp on a selected target cell for too short a time, resulting in frequent cell reselection, or the target cell selected by the terminal device is not suitable for a service(s) initiated by the terminal device, so that the terminal device needs to perform handover or redirection, and thus affecting the service performance.

### SUMMARY

The present disclosure provides a method for cell reselection, a terminal device, and a network device.

In order to achieve the above objective, the present disclosure provides the following technical solutions

In a first aspect, a method for cell reselection is provided. The method for cell reselection includes the following. A future motion trajectory and/or a service to be initiated in the future is predicted, where the future motion trajectory is covered by at least one cell, and a service type of the service to be initiated in the future corresponds to at least one frequency. A signal quality level of the at least one cell and/or a frequency priority of the at least one frequency is adjusted. Cell reselection is performed by using the adjusted signal quality level of the at least one cell and/or the adjusted frequency priority.

In a second aspect, the present disclosure further provides a terminal device. The terminal device includes a transceiver, a processor coupled to the transceiver, and a memory storing a computer program which, when executed by the terminal device, causes the terminal device to perform the following. A future motion trajectory and/or a service to be initiated in the future is predicted, where the future motion trajectory is covered by at least one cell, and the service to be initiated in the future corresponds to at least one frequency. A signal quality level of the at least one cell and/or a frequency priority of the at least one frequency is adjusted. Cell reselection is performed by using the adjusted signal quality level and/or the adjusted frequency priority.

In a third aspect, the present disclosure further provides a network device. The network device includes a transceiver, a processor coupled to the transceiver, and a memory storing a computer program which, when executed by the network device, causes the network device to send a cell reselection enhancement parameter, where the cell reselection enhancement parameter is used to adjust a signal quality level of at least one cell and/or a frequency priority of at least one frequency, where the at least one cell covers a future motion trajectory, the at least one frequency corresponds to a service to be initiated in the future, and the adjusted cell signal quality level of the at least one cell and/or the adjusted frequency priority are used for cell reselection.

### BRIEF DESCRIPTION OF THE DRAWINGS

FIG. 1 is a flow chart of a method for cell reselection provided in embodiments of the present disclosure.

FIG. 2 is an interactive flow chart of a method for cell reselection provided in embodiments of the present disclosure.

FIG. 3 is an interactive flow chart of another method for cell reselection provided in embodiments of the present disclosure.

FIG. 4 is an interactive flow chart of yet another method for cell reselection provided in embodiments of the present disclosure.

FIG. 5 is a schematic structural diagram of an apparatus for cell reselection provided in embodiments of the present disclosure.

FIG. 6 is a schematic diagram illustrating a hardware structure of an apparatus for cell reselection provided in embodiments of the present disclosure.

### DETAILED DESCRIPTION

The communication systems to which the embodiments of the present disclosure are applicable include, but are not limited to, a long term evolution (LTE) system, a fifth generation (5G) system, a new radio (NR) system, a future evolved system, or multiple communication fusion systems. The 5G system can be a non-standalone (NSA) 5G system or a standalone (SA) 5G system. The technical solutions of the present disclosure are also applicable to other network architectures, including but not limited to a relay network architecture, a dual connectivity (DC) architecture, a vehicle-to-everything (V2X) architecture, etc.

The present disclosure mainly relates to the communication between a terminal device and a network device.

The network device in the embodiments of the present disclosure may also be referred to as an access network device, for example, may be a base station (BS) (also referred to as a base station device). The network device is a device deployed in a radio access network (RAN) to provide wireless communication functions. For example, the device that provides base station functions in the second generation (2G) network includes a base transceiver station (BTS), the device that provides base station functions in the third generation (3G) network includes a node B (NodeB), the device that provides base station functions in the fourth generation (4G) network includes an evolved node B (eNB), the device that provides base station functions in a wireless local area network (WLAN) is an access point (AP), and the device that provides base station functions in NR includes a next generation node base station (gNB) and an evolved node B (ng-eNB), where communication between the gNB and the terminal device is performed using NR technology, communication between the ng-eNB and the terminal device is performed using evolved universal terrestrial radio access (E-UTRA) technology, and both the gNB and the ng-eNB can be connected to the 5G core network. The network device in the embodiments of the present disclosure also includes a device that provides base station functions in a future new communication system, etc.

The terminal device in the embodiments of the present disclosure may refer to various forms of access terminals, user units, user stations, mobile platforms, mobile stations (MS), remote stations, remote terminals, mobile devices, user terminals, wireless communication devices, user agents, or user devices. The terminal device may also be a cellular phone, a cordless phone, a session initiation protocol (SIP) phone, a wireless local loop (WLL) station, a personal digital assistant (PDA), a handheld device with wireless communication function, a computing device or other processing device connected to a wireless modem, a vehicle-mounted device, a wearable device, a terminal device in a future 5G network or a terminal device in a future evolved public land mobile network (PLMN), etc., which is not limited in the embodiments of the present disclosure. The terminal device may also be referred to as user equipment (UE), a terminal, etc.

As described in the background technology, in the related art, cell reselection is performed using a cell reselection parameter(s) in system information or a cell reselection parameter(s) configured via dedicated signaling. Using these parameters do not take into account the future movement trajectory of a single terminal device or a service(s) to be initiated in the future by a single terminal device, so that personalized cell reselection of the terminal device cannot be realized, which may cause some unnecessary and unsuitable cell reselection. For example, the terminal device may camp on a selected target cell for too short a time. If a target cell selected by the terminal device is unsuitable for a service(s) initiated by the terminal device, the terminal device needs to perform handover or redirection, and thus affecting the service performance.

In the technical solutions of the present disclosure, the terminal device can predict a future movement trajectory of the terminal device or a service to be initiated in the future by the terminal device. Thus, when the terminal device performs cell reselection, the terminal device can adjust a signal quality level of a cell on the future movement trajectory, or a frequency priority of a frequency corresponding to the predicted service, so as to improve the probability of reselecting the above cell or the probability of reselecting a cell on the above frequency during cell reselection. Since the time that the terminal device will camp on the cell on the future movement trajectory may not be too short, and the cell on the frequency corresponding to the predicted service can ensure the smooth development of the predicted service, by means of the above solutions for cell reselection, the case that the terminal device reselects a cell that is not suitable for an initiated service(s) and frequent cell reselection and so on can be avoided, thereby optimizing cell reselection, ensuring the communication performance of the terminal device, and improving the communication experience of the user.

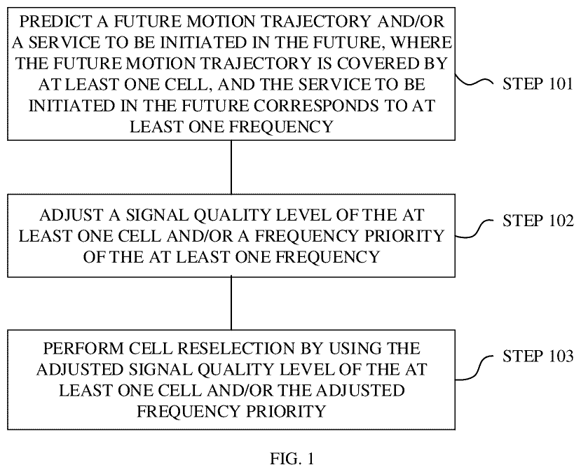

Referring to FIG. 1, a method provided in the present disclosure includes the following.

Step 101, a terminal device predicts a future motion trajectory and/or a service to be initiated in the future, where the future motion trajectory is covered by at least one cell, and the service to be initiated in the future corresponds to at least one frequency.

Step 102, the terminal device adjusts a signal quality level of the at least one cell and/or a frequency priority of the at least one frequency.

Step 103, cell reselection is performed by using the adjusted signal quality level of the at least one cell and/or the adjusted frequency priority.

It may be pointed out that, the serial numbers of the steps in the embodiment do not limit the execution order of the steps.

It may be understood that, in a specific implementation, the method for cell reselection can be implemented in the form of a software program, and the software program is run in a chip or a processor integrated in a chip module. The method can also be implemented in the form of software combined with hardware, which is not limited in the present disclosure.

In the specific implementation of step 101, the terminal device can predict the future motion trajectory and/or the service to be initiated in the future based on historical information of the terminal device. Specifically, the terminal device can predict the future motion trajectory based on a historical route of the terminal device and information of a cell(s) on the historical route where the terminal device camped on. Furthermore, the terminal can make a comprehensive prediction based on historical cell residence information, historical motion trajectory information, current motion direction, current speed and other information of the terminal device to obtain the future motion trajectory of the terminal device. For example, historical cells where the terminal device camped on at the same point of time at the current position and historical cells where the terminal device camped on within a period of time after leaving the residence cell are counted, and multiple cells are selected from the above historical cells to characterize the predicted future motion trajectory. The future motion trajectory may refer to an area/route that the terminal device will pass through in the future, where the area may refer to a cell or a tracking area, and the route may refer to a route indicated by latitude and longitude information or indicated by other information used for location representation.

In specific implementations, the terminal device can predict the service to be initiated in the future based on historical services. The terminal device can make prediction based on historical service information, behavioral characteristic statistics, current location, and other information. For example, the user of the terminal device may browse WeChat in the morning and make phone calls in the afternoon. In this case, when the current time is afternoon, it can be predicted that the service to be initiated in the future will be paging. Alternatively, for example, the terminal device in the factory performs specific service 1 at a fixed time, etc., then when the current time is the above fixed time, it can be predicted that the terminal device in the factory will initiate service 1 in the future.

It may be noted that, a correspondence between service types and frequencies can be pre-set by the standard communication protocol or pre-configured by the network device, which is not limited in the present disclosure. The terminal device will need to access a cell on the future movement trajectory, and/or perform a service on a frequency corresponding to the service to be initiated in the future, which means that the terminal device needs to camp on the above-mentioned cell and/or the cell on the frequency, and thus the terminal device needs to predict the future movement trajectory and/or the service to be initiated in the future. Then next, the terminal device needs to reselect the above-mentioned cell as much as possible.

For existing cell reselection, for scenario 1 of equal-priority neighboring cells and serving cells or of equal-priority frequency neighboring cells and serving cells: the terminal device needs to calculate signal quality levels (i.e., R values) of the serving cells and the neighboring cells, sort the serving cells and the neighboring cells, and select a cell with the highest R value as a target cell for reselection. The above process is the R-criterion for cell reselection. For scenario 2 of unequal-priority inter-frequency neighboring cells and serving cells: the terminal device selects the target cell in descending order of priority frequencies. Specifically, if the frequency priority of the neighboring cell is higher than that of the serving cell, in the case where the signal quality of the neighboring cell is higher than threshold Th1 within a certain period of time and the terminal device camps on the serving cell for more than 1 second, the terminal device can reselect the neighboring cell. If the frequency priority of the neighboring cell is lower than that of the serving cell, in the case where the signal quality of the serving cell is lower than threshold Th2, the signal quality of the neighboring cell is higher than threshold Th3 within a certain period of time, and the terminal device camps on the serving cell for more than 1 second, the terminal device can reselect the neighboring cell. If there are multiple neighboring cells on the same frequency that fulfill the above conditions, the R criterion is used to select a target cell on the frequency.

In the specific implementation of step 102 and step 103, the at least one cell covering the future motion trajectory is a neighboring cell for the current serving cell. When performing cell reselection, the terminal device can calculate the signal quality level of each cell according to the R-criterion, and then adjust the signal quality level to increase the probability of the terminal device reselecting the above cell. Specifically, the signal quality level of the at least one cell can be adjusted to a higher value.

In addition, for the frequency priority of the at least one frequency corresponding to the predicted service to be initiated in the future, the frequency priority may be adjusted to increase the probability of the terminal device reselecting a cell on the frequency. Specifically, the frequency priority may be adjusted to be a higher value.

In a specific implementation, for adjusting the signal quality level of a cell(s), the signal quality levels of all cells covering the future movement trajectory may be adjusted, or the signal quality levels of some cells covering the future movement trajectory may be adjusted. Accordingly, for adjusting the frequency priority of a frequency(ies), the frequency priorities of all frequencies corresponding to the service to be initiated in the future may be adjusted, or the frequency priorities of some frequencies corresponding to the service to be initiated in the future may be adjusted.

Furthermore, in the case where there are multiple services to be initiated in the future, the terminal device may select to adjust a frequency(ies) corresponding to one or more services with the highest priority. The priority of a service may be configured to the terminal device by the network side or pre-defined by the standard communication protocol. Alternatively, frequency priorities of all frequencies corresponding to the multiple services to be initiated in the future are adjusted.

In the embodiment of the present disclosure, when determining cell reselection, if the future motion trajectory and/or the service to be initiated in the future is valid, the terminal device adopts the above scheme to perform cell reselection. If the future motion trajectory deviates greatly from the actual position, or the service to be initiated in the future deviates greatly from the current service, for example, a predicted occurrence probability of the service to be initiated in the future is relatively low, the terminal device can perform cell reselection according to the traditional method for cell reselection. The terminal device further repeats the above steps 101 to 103 for subsequent cell reselection.

Since the trajectory and the service of the terminal device have certain regularity, for example, the user usually passes through a certain specific route, and often uses a certain service, so that it is possible to predict the future movement trajectory of the terminal device or the service to be initiated in the future by the terminal device. In the embodiments of the present disclosure, the terminal device performs cell reselection according to the future movement trajectory or the service to be initiated in the future, so that the terminal device can reselect a cell where the terminal device will camp on for a relatively long time or a cell suitable for the service to be initiated, and thus the case that the terminal device reselects a cell that is not suitable for the service to be initiated and frequent cell reselection, etc., can be avoided, thereby optimizing cell reselection, ensuring the communication performance of the terminal device, and improving the communication experience of the user.

The specific parameter(s) used to adjust the signal quality level of a cell and/or frequency priority may be specified by the standard communication protocol, or may be configured by the network device to the terminal device.

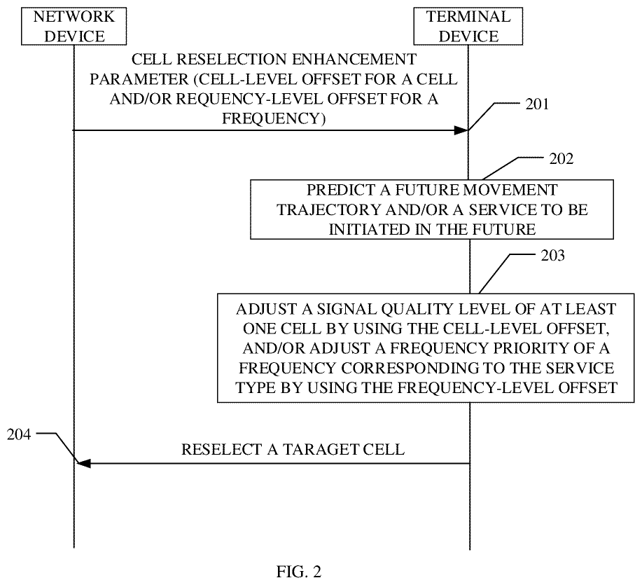

The following is illustrated by taking that the network device configures an adjustment parameter(s) for the terminal device as an example. FIG. 2 illustrates an interaction process between the network device and the terminal device. The network device in the embodiment of the present disclosure may be an access network device, or any other device that can implement the process at the network side, which is not limited in the present disclosure.

In step 201, the network device sends a cell reselection enhancement parameter to the terminal device. Accordingly, the terminal device receives the cell reselection enhancement parameter. The cell reselection enhancement parameter at least includes a cell-level offset for a cell and/or a frequency-level offset for a frequency.

In the embodiment, the cell-level offset is used to adjust a signal quality level of a cell, and the cell-level offset is an offset used for calculating a signal quality level of a cell during cell reselection. The frequency-level offset is used to adjust a frequency priority of a frequency, and the frequency-level offset is an offset used for calculating a frequency priority of a cell during cell reselection.

The cell-level offset and the frequency-level offset may be positive or negative, and may be adaptively configured according to the actual application scenario, which is not limited in the present disclosure.

In a specific embodiment, the cell reselection enhancement parameter includes one or more of the following: 1. cell-level offset for a specific cell, which may be one or more; 2. use condition of the cell-level offset for the specific cell, which may be one or more; 3. cell-level offset for a public cell, which may be one or more; 4. use condition of the cell-level offset for the public cell; 5. frequency-level offset for a specific frequency, which may be one or more; 6. use condition of the frequency-level offset for the specific frequency, which may be one or more.

Specifically, in the case where the cell reselection enhancement parameter includes the frequency-level offset for a specific frequency, the specific frequency may be selected from at least one frequency corresponding to a service to be initiated in the future.

In a specific implementation, the network device can send the cell reselection enhancement parameter via radio resource control (RRC) signaling. Further, the RRC signaling may be RRC dedicated signaling, such as RRC Release or RRC Reconfiguration. The RRC signaling may also be RRC common signaling, such as system information.

In step 202, the terminal device predicts a future movement trajectory and/or a service to be initiated in the future.

In step 203, the terminal device adjusts a signal quality level of at least one cell by using the cell-level offset, and/or adjusts a frequency priority of at least one frequency by using the frequency-level offset.

In a specific embodiment, the calculation formula for signal quality level Rn of a neighboring cell is as follows: Rn=Qmeas,n−Qoffset−Qoffsettemp1, where Qmeas,n is a reference signal receiving power (RSRP) measurement value of the neighboring cell, Qoffset is an offset between a serving cell and the neighboring cell that is configured by the network device, Qoffsettemp1 is the cell-level offset, and Qoffsettemp1 may be positive or negative.

Furthermore, in the case where the cell-level offset is the cell-level offset for a public cell, the terminal device uses the cell-level offset to calculate the signal quality level of each neighboring cell. In the case where the cell-level offset is the cell-level offset for a specific cell, the terminal device uses the cell-level offset corresponding to the specific cell to calculate the signal quality level of the specific cell. For example, in the case where a cell-level offset for cell 1 and a cell-level offset for cell 2 are configured, the cell-level offset for cell 1 is used to calculate the signal quality level of cell 1, and the cell-level offset for cell 2 is used to calculate the signal quality level of cell 2.

In a specific embodiment of the present disclosure, the cell reselection enhancement parameter further includes the use condition of the cell-level offset, and the use condition of the cell-level offset includes each cell-level offset and cell residence time corresponding to each cell-level offset. Meanwhile, when predicting the future motion trajectory, the terminal device can also predict a predicted residence time for the at least one cell covering the future motion trajectory. Specifically, the above-mentioned predicted residence time can be determined based on the residence time for a historical cell where the terminal device camped on at the same point of time at the current location, and the residence time for a historical cell where the terminal device camped on within a period of time after leaving the residence cell.

Therefore, for each cell, the terminal device can select a cell-level offset used to adjust the signal quality level of the cell according to the relationship between cell residence time corresponding to each cell-level offset in the use condition of the cell-level offset and predicted residence time.

Example 1: a use condition of cell-level offset 1 is that the residence time for a cell is greater than or equal to threshold T1. Thus, when the predicted residence time for cell 1 predicted by the terminal device is greater than or equal to threshold T1, cell-level offset 1 is used to adjust a signal quality level of cell 1; when the predicted residence time for cell 2 predicted by the terminal device is less than threshold T1, the terminal device does not use cell-level offset 1 to adjust a signal quality level of cell 2.

Example 2: a use condition for cell-level offset 2 is that the residence time for a cell is less than threshold T1. Thus, when the predicted residence time for cell 2 predicted by the terminal device is less than threshold T1, the terminal device uses cell-level offset 2 to adjust a signal quality level of cell 2; when the predicted residence time for cell 1 predicted by the terminal device is greater than or equal to threshold T1, the terminal device does not use cell-level offset 2 to adjust a signal quality level of cell 1.

Example 3: the network device configures three cell-level offsets, namely, offsets x2, x3, and x4, and configures the use condition of offset x2 as that the residence time is less than or equal to threshold T3, the use condition of offset x3 as that the residence time is greater than threshold T3 and less than threshold T4, and the use condition of offset x4 as that the residence time is greater than or equal to threshold T4. Thus, when the predicted residence time for cell 3 predicted by the terminal device is less than or equal to threshold T3, the terminal device uses offset x2 to adjust a signal quality level of cell 3; when the predicted residence time for cell 3 predicted by the terminal device is greater than threshold T3 and less than threshold T4, the terminal device uses offset x3 to adjust the signal quality level of cell 3; when the predicted residence time for cell 3 predicted by the terminal device is greater than or equal to threshold T4, the terminal device uses offset x4 to adjust the signal quality level of cell 3.

In the embodiment of the present disclosure, the network device configures the cell-level offset, and during cell reselection, the terminal device adopts the cell-level offset according to the predicted motion trajectory, so as to realize personalized cell reselection, thereby improving the efficiency of cell reselection and improving the energy-saving performance of the terminal device.

Accordingly, in a scenario where the terminal device predicts a service to be executed in the future, a frequency corresponding to a service type of the service to be executed in the future has a predicted occurrence probability, and the use condition of the frequency-level offset includes each frequency-level offset and an occurrence probability range corresponding to each frequency-level offset. The terminal device can select a frequency-level offset corresponding to an occurrence probability that matches a predicted occurrence probability of a frequency corresponding to a service type, and use the selected frequency-level offset to adjust a frequency priority of at least one frequency.

Specifically, a predicted occurrence probability of a frequency corresponding to a service can be determined based on the number of times the terminal device uses the frequency to execute the service within a certain period of time in historical service information. If multiple services correspond to the same frequency, multiple predicted occurrence probabilities may be calculated in this case, and then the maximum probability can be determined as the predicted occurrence probability of the frequency. Optionally, another way is to select the occurrence probability of the highest priority service. The priority of a service is configured by the network side or defined by the standard communication protocol.

Example 4: the network device configures frequency-level offset Foffsettemp1, and the use condition of frequency-level offset Foffsettemp1 is that the occurrence probability is greater than threshold P1. Thus, when a predicted occurrence probability of frequency 1 corresponding to a service type of a predicted service is greater than threshold P1, the terminal device uses frequency-level offset Foffsettemp1 to adjust a frequency priority of frequency 1.

Example 5: the network device configures two frequency-level offsets, namely offset Foffsettemp2 and offset Foffsettemp3. The use condition of offset Foffsettemp2 is that the occurrence probability is greater than threshold P2 and less than threshold P3, and the use condition of offset Foffsettemp3 is that the occurrence probability is greater than threshold P3. Thus, when a predicted occurrence probability of frequency 1 corresponding to a service type of a predicted service is greater than threshold P2 and less than threshold P3, the terminal device uses frequency-level offset Foffsettemp2 to adjust a frequency priority of frequency 1. When the predicted occurrence probability of frequency 1 corresponding to the service type of the predicted service is greater than threshold P3, the terminal device uses frequency-level offset Foffsettemp3 to adjust the frequency priority of frequency 1.

In the embodiment of the present disclosure, the network device configures the frequency-level offset, and during cell reselection, the terminal device adopts the frequency-level offset according to the service type of the predicted service, which can realize personalized cell reselection, thereby improving the performance of the service.

Referring to FIG. 2 again, in step 204, the terminal device reselects a target cell. For the manner of selecting the target cell, reference can be made to the relevant illustrations of the above embodiments, which will not be repeated here.

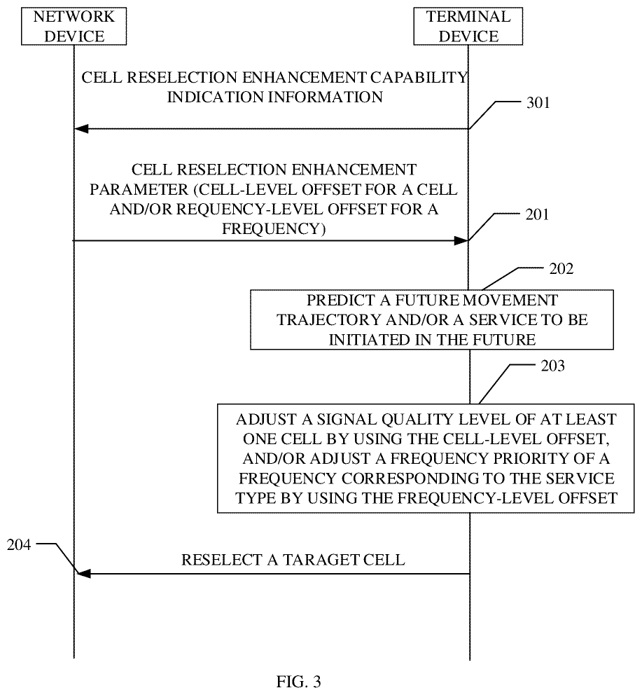

Refer to FIG. 3, which is another flow chart illustrating interaction between the terminal device and the network device.

Different from the embodiment illustrated in FIG. 2, in step 301, the terminal device can report cell reselection enhancement capability indication information to the network device.

In a specific implementation, the cell reselection enhancement capability indication information indicates whether the terminal device supports adjusting a signal quality level of a cell and/or a frequency priority of a frequency, that is, adjusting according to a future movement trajectory and/or a service to be initiated in the future. After receiving the cell reselection enhancement capability indication information, the network device can learn the capability of the terminal device, that is, whether the terminal device supports adjusting the signal quality level of a cell and/or the frequency priority of a frequency. If the terminal device supports adjusting the signal quality level of a cell and/or the frequency priority of a frequency, the network device can send a cell reselection enhancement parameter to avoid unnecessary signaling overhead. The network device can send the cell reselection enhancement parameter to the terminal device by carrying the cell reselection enhancement parameter in dedicated RRC signaling.

In another optional embodiment, before step 201, the terminal device can also send a cell reselection enhancement parameter request to the network device.

In a specific implementation, the cell reselection enhancement parameter request may be carried in a message for random access, for example, may be indicated via message 1 for random access, or carried in message 3 for random access. The cell reselection enhancement parameter request is used to request the cell reselection enhancement parameter. After receiving the cell reselection enhancement parameter request from the terminal device, the network device may carry the cell reselection enhancement parameter in system information.

That is to say, the network device sends the cell reselection enhancement parameter to the terminal device only after receiving the request from the terminal device.

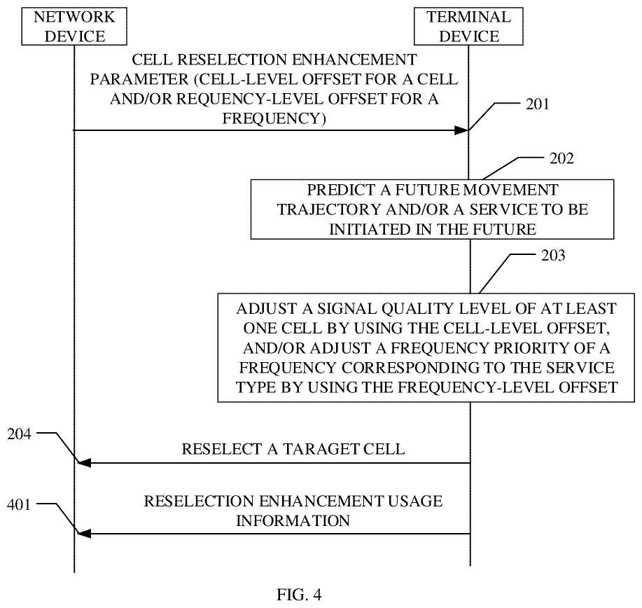

In a non-limiting embodiment, referring to FIG. 4, after the terminal device reselects the target cell, in step 401, the terminal device reports cell reselection enhancement usage information to the network device.

In a specific implementation, the cell reselection enhancement usage information includes enhancement usage information for a single cell reselection or multiple cell reselections.

The enhancement usage information for a single cell reselection indicates one or more of the following: an original cell for the cell reselection, a target cell for the cell reselection, an indication indicative of use of signal quality level adjustment in the cell reselection, an indication indicative of use of frequency priority adjustment in the cell reselection, a signal-quality-level adjustment amount for the cell reselection, and a frequency-priority adjustment amount for the cell reselection. Specifically, the signal-quality-level adjustment amount may be a cell-level offset used, and the frequency-priority adjustment amount may be a frequency-level offset used.

Furthermore, the cell reselection enhancement usage information may be carried in an RRC message. The RRC message may be selected from the following messages: UEInformationResponse, RRCSetupComplete, RRCResumeComplete, and RRCReconfigurationComplete.

In the embodiment of the present disclosure, the terminal device reports the cell reselection enhancement usage information to the network device, so that the network device can learn the specific parameter used by the terminal device to access the target cell, so that the network device can modify, configure, or delete the offset parameter and so on, making parameter configuration more reasonable, and thus in subsequent cell reselection, the terminal device can reselect a better cell, thereby improving the network performance and the performance of cell reselection of the terminal device.

For more specific implementations of the embodiment of the present disclosure, reference can be made to the aforementioned embodiments, which will not be repeated here.

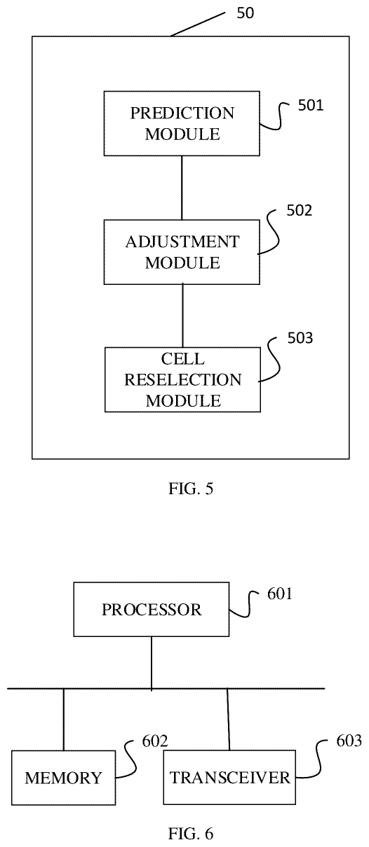

Referring to FIG. 5, FIG. 5 illustrates an apparatus 50 for cell reselection. The apparatus 50 for cell reselection includes a prediction module 501, an adjustment module 502, and a cell reselection module 503.

The prediction module 501 is configured to predict a future motion trajectory and/or a service to be initiated in the future, where the future motion trajectory is covered by at least one cell, and the service to be initiated in the future corresponds to at least one frequency.

The adjustment module 502 is configured to adjust a signal quality level of the at least one cell and/or a frequency priority of the at least one frequency.

The cell reselection module 503 is configured to perform cell reselection using the adjusted signal quality level of the at least one cell and/or the adjusted frequency priority.

In a specific implementation, the above-mentioned apparatus 50 for cell reselection may correspond to a chip with a cell reselection function in the terminal device, such as a system-on-a-chip (SOC), a baseband chip, etc.; or correspond to a chip module with a cell reselection function in the terminal device; or correspond to a chip module with a data processing function; or correspond to a terminal device.

For other related illustrations about the apparatus 50 for cell reselection, reference can be made to the related illustrations in corresponding embodiments of FIG. 1 to FIG. 3, which will not be repeated here.

The present disclosure further discloses another apparatus for cell reselection, which includes a communication module. The communication module is configured to send a cell reselection enhancement parameter, where the cell reselection enhancement parameter is used to adjust a signal quality level of at least one cell and/or a frequency priority of at least one frequency. The at least one cell covers a future motion trajectory, and the at least one frequency corresponds to a service to be initiated in the future. The adjusted signal quality level of the cell and/or the adjusted frequency priority are used for cell reselection.

In a specific implementation, the above-mentioned apparatus for cell reselection may correspond to a chip with a cell reselection function in a network device, such as an SOC, a baseband chip, etc.; or correspond to a chip module with a cell reselection function in the network device; or correspond to a chip module with a data processing function, or correspond to the network device.

The modules/units included in the apparatus and products described in the above embodiments may be software modules/units or hardware modules/units, or may be partially software modules/units and partially hardware modules/units. For example, for each apparatus or product applied to or integrated in the chip, each module/unit contained therein may be implemented by hardware such as circuits, or part of modules/units may be implemented in the form of software programs that can be run by a processor integrated in the chip, and the remaining modules/units (if any) may be implemented by hardware such as circuits. For each apparatus or product applied to or integrated in the chip, each module/unit contained therein may be implemented by hardware such as circuits, and different modules/units may be located in the same component (e.g., chip, circuit module, etc.) or different components of the chip module, or at least part of the modules/units may be implemented by software programs that may be implemented by a processor integrated in the chip module, and the remaining part of the modules/units (if any) may be implemented by hardware such as circuits, etc. For each apparatus or product applied to or integrated in the terminal device, each module/unit contained therein may be implemented by hardware such as circuits, etc., and different modules/units may be located in the same component (e.g., chip, circuit module, etc.) or different components of the terminal device, or at least part of the modules/units may be implemented by software programs that may be implemented by a processor integrated in the terminal device, and the remaining part of the modules/units (if any) may be implemented by hardware such as circuits, etc.

The embodiments of the present disclosure further disclose a storage medium, which is a computer-readable storage medium storing a computer program, and when the computer program is run, the steps of the methods illustrated in FIGS. 1-3 can be executed. The storage medium may include a read-only memory (ROM), a random access memory (RAM), a disk or an optical disk, etc. The storage medium may further include a non-volatile memory or a non-transitory memory, etc.

Referring to FIG. 6, the present disclosure further provides a schematic diagram illustrating hardware structure of a communication device. The device includes a processor 601, a memory 602, and a transceiver 603.

The processor 601 may be a general-purpose central processing unit (CPU), a microprocessor, an application-specific integrated circuit (ASIC), or one or more integrated circuits for controlling the execution of the program of the present disclosure. The processor 601 may further include multiple CPUs, and the processor 601 may be a single-core (single-CPU) processor or a multi-core (multi-CPU) processor. The processor here may refer to one or more apparatuses, devices, circuits, or processing cores for processing data (such as computer program instructions).

The memory 602 may be a ROM or other types of static storage devices that can store static information and instructions, a RAM or other types of dynamic storage devices that can store information and instructions, or an electrically erasable programmable read-only memory (EEPROM), a compact disc read-only memory (CD-ROM) or other optical disc storage, optical disc storage (including a compressed optical disc, a laser disc, an optical disc, a digital versatile disc, a Blu-ray disc, etc.), a disk storage medium or other magnetic storage device, or any other medium that can be used to carry or store desired program codes in the form of instructions or data structure and can be accessed by a computer, which is not limited in the embodiments of the present disclosure. The memory 602 may exist independently (in this case, the memory 602 may be located outside the device or inside the device), or may be integrated with the processor 601. The memory 602 may contain computer program codes. The processor 601 is configured to execute the computer program codes stored in the memory 602, thereby realizing the methods provided in the embodiments of the present disclosure.

The processor 601, the memory 602, and the transceiver 603 are connected via a bus. The transceiver 603 is configured to communicate with other devices or a communication network. Optionally, the transceiver 603 may include a transmitter and a receiver. An element configured to implement a receiving function in the transceiver 603 can be regarded as a receiver, and the receiver is configured to perform the receiving step in the embodiments of the present disclosure. An element configured to implement the transmission function in the transceiver 603 can be regarded as a transmitter, and the transmitter is configured to perform the transmission step in the embodiment of the present disclosure.

In the case where the structural diagram in FIG. 6 is used to illustrate the structure of the terminal device involved in the above embodiments, the processor 601 is configured to control and manage the actions of the terminal device, for example, the processor 601 is configured to support the terminal device to execute steps 101-103 in FIG. 1, steps 201-204 in FIG. 2, steps 301, 201, 202, 203, 204, and 302 in FIG. 3, steps 201, 202, 203, 204, and 401 in FIG. 4, and/or actions performed by the terminal device in other processes described in the embodiments of the present disclosure. The processor 601 can communicate with other network entities through the transceiver 603, for example, communicate with the above network device through the transceiver 603. The memory 602 is configured to store program codes and data of the terminal device.

In the case where the structural diagram in FIG. 6 is used to illustrate the structure of the network device involved in the above embodiments, the processor 601 is configured to control and manage the actions of the network device, for example, the processor 601 is configured to support the network device to execute steps 201 and 204 in FIG. 2, steps 301, 201, 204, and 302 in FIG. 3, steps 201, 204, and 401 in FIG. 4, and/or actions performed by the network device in other processes described in the embodiments of the present disclosure. The processor 601 can communicate with other network entities through the transceiver 603, for example, communicate with the above terminal device through the transceiver 603. The memory 602 is configured to store program codes and data of the network device.

In the embodiment of the present disclosure, it is defined that a unidirectional communication link from the network device to the terminal device is a downlink, data transmitted on the downlink is downlink data, and a transmission direction of the downlink data is called a downlink direction; and it is defined that a unidirectional communication link from the terminal device to the network device is an uplink, data transmitted on the uplink is uplink data, and a transmission direction of the uplink data is called an uplink direction.

It may be understood that the term “and/or” in this article is only an illustration of an association relationship of associated objects, indicating that there may be three relationships. For example, A and/or B can represent: A exists alone, A and B exist at the same time, and B exists alone. In addition, the character “/” in this article indicates that associated objects before and after “/” are in an “or” relationship.

The terms “plurality”, “multiple”, and “a number of” appearing in the embodiments of the present disclosure refer to two or more.

The terms “first”, “second” and so on appearing in the embodiments of the present disclosure are only used for illustrating and distinguishing the objects, do not indicate order, also do not indicate any special limitation on the number of devices in the embodiments of the present disclosure, and cannot constitute any limitation on the embodiments of the present disclosure.

The terms “connection” and “coupling” that appears in the embodiments of the present disclosure refer to various connection manners such as direct connection or indirect connection for achieving communication between devices, and the embodiments of the present disclosure is not limited thereto.

The above embodiments may be implemented in whole or in part by software, hardware, firmware or any other combination thereof. When implemented using software, the above embodiments may be implemented in whole or in part in the form of a computer program product. The computer program product includes one or more computer instructions or computer programs. When the computer instructions or computer programs are loaded or executed on a computer, the processes or functions described in the embodiments of the present disclosure are generated in whole or in part. The computer may be a general-purpose computer, a special-purpose computer, a computer network, or other programmable device. The computer instructions may be stored in a computer-readable storage medium, or transmitted from one computer-readable storage medium to another computer-readable storage medium, for example, the computer instructions may be transmitted from one website site, computer, server or data center to another website site, computer, server or data center by wired or wireless means.

It may be understood that, in the various embodiments of the present disclosure, the magnitudes of the serial numbers of the above-mentioned processes does not mean the order of execution. The execution order of each process should be determined by its function and internal logic, and should not constitute any limitation on the implementation process of the embodiments of the present disclosure.

It may be understood that, the disclosed methods, apparatuses, and systems in the several embodiments provided in the present disclosure can be implemented in other ways. For example, the device embodiments described above are merely schematic. For example, the division of the units is only a logical function division, and there may be other division methods in actual implementation; for example, multiple units or components can be combined or integrated into another system, or some features can be ignored or not executed. Another point is that the mutual coupling or direct coupling or communication connection illustrated or discussed can be indirect coupling or communication connection of devices or units through some interfaces, which may be electrical, mechanical or other forms.

The units described as separate components may or may not be physically separated, and the components shown as units may or may not be physical units, that is, they may be located in one place or distributed on multiple network units. Some or all of the units may be selected according to actual needs to achieve the purpose of the solutions of the embodiments.

In addition, each functional unit in each embodiment of the present disclosure may be integrated into one processing unit, or each unit may be physically separated, or two or more units may be integrated into one unit. The above-mentioned integrated unit may be implemented in the form of hardware or in the form of hardware plus software functional units.

The above-mentioned integrated unit implemented in the form of a software functional unit can be stored in a computer-readable storage medium. The above-mentioned software functional unit may be stored in a storage medium, including a number of instructions for enabling a computer device (which may be a personal computer, a server, or a network device, etc.) to perform some steps of the method described in each embodiment of the present disclosure.

Although the present disclosure is disclosed as above, the present disclosure is not limited thereto. Any person skilled in the art can make various changes and modifications without departing from the spirit and scope of the present disclosure. Therefore, the protection scope of the present disclosure shall be subject to the scope defined by the claims.

1. A method for cell reselection, comprising:
predicting a future motion trajectory and/or a service to be initiated in the future, wherein the future motion trajectory is covered by at least one cell, and the service to be initiated in the future corresponds to at least one frequency;
adjusting a signal quality level of the at least one cell and/or a frequency priority of the at least one frequency; and
performing cell reselection by using the adjusted signal quality level of the at least one cell and/or the adjusted frequency priority.

2. The method for cell reselection according to claim 1, wherein adjusting the signal quality level of the at least one cell and/or the frequency priority of the at least one frequency comprises:
adjusting the signal quality level of the at least one cell and/or the frequency priority of the at least one frequency according to a cell reselection enhancement parameter, wherein the cell reselection enhancement parameter comprises a cell-level offset for a cell and/or a frequency-level offset for a frequency.

3. The method for cell reselection according to claim 2, wherein the cell-level offset comprises a cell-level offset for a specific cell and/or a cell-level offset for a public cell, and the cell-level offset is implemented as one or more cell-level offsets; the frequency-level offset comprises a frequency-level offset for a specific frequency, and the frequency-level offset is implemented as one or more frequency-level offsets.

4. The method for cell reselection according to claim 2, wherein adjusting the signal quality level of the at least one cell and/or the frequency priority of the at least one frequency comprises:
adjusting the signal quality level of the at least one cell by using the cell-level offset, and/or adjusting the frequency priority of the at least one frequency by using the frequency-level offset.

5. The method for cell reselection according to claim 2, wherein the cell reselection enhancement parameter further comprises a use condition of the cell-level offset and/or a use condition of the frequency-level offset.

6. The method for cell reselection according to claim 5, wherein the at least one cell has predicted residence time, the use condition of the cell-level offset comprises each cell-level offset and cell residence time corresponding to each cell-level offset, and adjusting the signal quality level of the at least one cell by using the cell-level offset comprises:
for each cell in the at least one cell,
selecting a cell-level offset used for adjusting a signal quality level of the cell according to a relationship between predicted residence time for each cell in the at least one cell and the cell residence time corresponding to each cell-level offset; and
adjusting the signal quality level of the cell by using the selected cell-level offset.

7. The method for cell reselection according to claim 5, wherein the at least one frequency has a predicted occurrence probability, the use condition of the frequency-level offset comprises each frequency-level offset and an occurrence probability corresponding to each frequency-level offset, and adjusting the frequency priority of the at least one frequency by using the frequency-level offset comprises:
selecting a frequency-level offset corresponding to an occurrence probability that matches the predicted occurrence probability for the at least one frequency; and
adjusting the frequency priority of the at least one frequency by using the selected frequency-level offset.

8. The method for cell reselection according to claim 2, further comprising:
receiving the cell reselection enhancement parameter, wherein the cell reselection enhancement parameter is carried in a radio resource control (RRC) signaling.

9. The method for cell reselection according to claim 8, further comprising:
sending or indicating a cell reselection enhancement parameter request via a message for random access, wherein the cell reselection enhancement parameter request is used to request the cell reselection enhancement parameter.

10. The method for cell reselection according to claim 1, further comprising:
reporting cell reselection enhancement capability indication information, wherein the cell reselection enhancement capability indication information indicates whether a terminal device supports adjusting the signal quality level of the at least one cell and/or the frequency priority of the at least one frequency according to the future motion trajectory and/or the service to be initiated in the future.

11. The method for cell reselection according to claim 1, further comprising:
reporting cell reselection enhancement usage information, wherein the cell reselection enhancement usage information indicates one or more of the following: an original cell for cell reselection, a target cell for cell reselection, an indication indicative of use of signal quality level adjustment in cell reselection, an indication indicative of use of frequency priority adjustment in cell reselection, a cell-signal-quality-level adjustment amount, and a frequency-priority adjustment amount.

12-15. (canceled)

16. A terminal device, comprising:
a transceiver;
a processor coupled to the transceiver; and
a memory storing a computer program which, when executed by the processor, causes the terminal device to:
predict a future motion trajectory and/or a service to be initiated in the future, wherein the future motion trajectory is covered by at least one cell, and the service to be initiated in the future corresponds to at least one frequency;
adjust a signal quality level of the at least one cell and/or a frequency priority of the at least one frequency; and
perform cell reselection by using the adjusted signal quality level of the at least one cell and/or the adjusted frequency priority.

17. A network device, comprising:
a transceiver;
a processor coupled to the transceiver; and
a memory storing a computer program which, when executed by the processor, causes the network device to:
send a cell reselection enhancement parameter, wherein the cell reselection enhancement parameter is used to adjust a signal quality level of at least one cell and/or a frequency priority of at least one frequency, wherein the at least one cell covers a future motion trajectory, the at least one frequency corresponds to a service to be initiated in the future, and the adjusted cell signal quality level of the at least one cell and/or the adjusted frequency priority are used for cell reselection.

18-20. (canceled)

21. The terminal device according to claim 16, wherein the computer program executed by the processor to cause the terminal device to adjust the signal quality level of the at least one cell and/or the frequency priority of the at least one frequency is executed by the processor to cause the terminal device to:
adjust the signal quality level of the at least one cell and/or the frequency priority of the at least one frequency according to a cell reselection enhancement parameter, wherein the cell reselection enhancement parameter comprises a cell-level offset for a cell and/or a frequency level offset for a frequency.

22. The terminal device according to claim 21, wherein the cell-level offset comprises a cell-level offset for a specific cell and/or a cell-level offset for a public cell, and the cell-level offset is implemented as one or more cell-level offsets; the frequency-level offset comprises a frequency-level offset for a specific frequency, and the frequency-level offset is implemented as one or more frequency-level offsets.

23. The terminal device according to claim 21, wherein the computer program executed by the processor to cause the terminal device to adjust the signal quality level of the at least one cell and/or the frequency priority of the at least one frequency is executed by the processor to cause the terminal device to:
adjust the signal quality level of the at least one cell by using the cell-level offset, and/or adjust the frequency priority of the at least one frequency by using the frequency-level offset.

24. The terminal device according to claim 21, wherein the cell reselection enhancement parameter further comprises a use condition of the cell-level offset and/or a use condition of the frequency-level offset.

25. The network device according to claim 17, wherein the computer program is further executed by the processor to cause the network device to:
receive a cell reselection enhancement parameter request via a message for random access, wherein the cell reselection enhancement parameter request is used to request the cell reselection enhancement parameter; and
send the cell reselection enhancement parameter in response to the cell reselection enhancement parameter request received.

26. The network device according to claim 17, wherein the computer program is further executed by the processor to cause the network device to:
receive cell reselection enhancement capability indication information, wherein the cell reselection enhancement capability indication information indicates whether a terminal device supports adjusting the signal quality level of the at least one cell and/or the frequency priority of the at least one frequency according to the future motion trajectory and/or the service to be initiated in the future; and
send the cell reselection enhancement parameter in response to the cell reselection enhancement capability indication information received.

27. The network device according to claim 17, wherein the computer program is further executed by the processor to cause the network device to:
receive cell reselection enhancement usage information, wherein the cell reselection enhancement usage information indicates one or more of the following: an original cell for cell reselection, a target cell for cell reselection, an indication indicative of use of signal quality level adjustment in cell reselection, an indication indicative of use of frequency priority adjustment in cell reselection, a cell-signal-quality-level adjustment amount, and a frequency-priority adjustment amount; and
optimize the cell reselection enhancement parameter according to the cell reselection enhancement usage information received.
